(19) United States
(12) Patent Application Publication
(10) Pub. No.: US 2024/0332677 A1
(43) Pub. Date: Oct. 3, 2024

(54) AIR BATTERY MODULE

(71) Applicant: FDK CORPORATION, Tokyo (JP)

(72) Inventors: Yoshiyuki Ogihara, Tokyo (JP); Takeshi Kajiwara, Tokyo (JP); Shohei Unoki, Tokyo (JP); Minori Nishi, Tokyo (JP)

(21) Appl. No.: 18/622,822

(22) Filed: Mar. 29, 2024

(30) Foreign Application Priority Data
Mar. 31, 2023 (JP) 2023-058423

(51) Int. Cl. H01M 12/08; H01M 4/80; H01M 4/86; H01M 8/0202; H01M 8/0239

(52) U.S. Cl. CPC H01M 12/08; H01M 4/808; H01M 4/8626; H01M 8/0239; H01M 8/0269

(57) ABSTRACT

An air battery module includes a plurality of air battery cells connected in series. Each air battery cell includes a negative electrode current collector, a negative electrode plate, a separator, a positive electrode current collector supporting an air electrode, a water-repellent film, and a flow channel plate. The positive electrode current collector includes a conductive frame and two conductive connection parts formed integrally with the frame and extending in a direction away from the negative electrode current collector. The two connection parts are formed so as to face each other with the air electrode interposed therebetween. When the positive electrode side of a battery cell is connected to the negative electrode side of an adjacent battery cell, the connection part of the battery cell is contact with the negative electrode current collector of the adjacent battery cell and electrically connected thereto.

### CROSS-REFERENCE TO RELATED APPLICATION(S)

This application claims priority to Japanese Application No. 2023-058423 filed on Mar. 31, 2023, the contents of which are incorporated by reference herein in its entirety.

### BACKGROUND

### Technical Field

The present disclosure relates to an air battery module and particularly to a battery pack in which a plurality of air cells that utilize oxygen in air are connected in series.

### Description of the Related Art

Air batteries are batteries that use oxygen in air as a positive electrode active material and have advantages in that their energy density is high and that their size and weight can be easily reduced. Examples of the air batteries include zinc air primary batteries practically used for hearing aids etc. Air secondary batteries including negative electrodes made of metals such as Li, Zn, Al, or Mg are expected to be developed as novel secondary batteries having a higher energy density than lithium ion secondary batteries.

To put air secondary batteries into practical use, it is necessary to develop battery packs including battery cells connected in series or parallel in order to increase the voltage and capacity of the batteries. Air cells require air (oxygen) for the discharge reaction. Therefore, to prepare a battery pack (module), it is necessary for the battery pack to have a structure including supply channels for supplying air to the cells. Accordingly, Japanese Unexamined Patent Application Publication No. 2017-084650 discloses an air battery module including a plurality of air cells connected to each other and arranged within one housing.

Japanese Unexamined Patent Application Publication No. 2014-194920 discloses a bipolar air battery module, which is an example of the battery pack. This bipolar air battery module is configured such that the negative electrode of one air battery cell and the positive electrode of an air battery cell adjacent to this cell are electrically connected via a wall material that separates these air battery cells from each other. This structure has advantages in that the connection resistance between cells is low, that a high energy density can be achieved in actual cells, and that the battery capacity can be freely designed irrespective of the size of the housing.

However, when a plurality of air cells are arranged in one housing to prepare a module, structural members such as the housing and a battery frame occupy a large proportion in the module. In this case, the actual energy density tends to decrease significantly, and the flow rates of air supplied to the battery cells tend to be uneven. This has resulted in the following drawbacks. It is difficult to assemble large modules due to the limitations on integration of battery cells, and the design flexibility is low due to the fixed size of the housing.

In bipolar battery modules, it is not possible to remove and replace only a malfunctioning battery cell, so that components such as electrodes are required to have high quality. In particular, distortion of components and misalignment of components during assembly of modules cause variations in capacity of the battery cells and electrolyte leakage. Moreover, increasing the number of stacked battery cells may cause instability in charging and discharging.

### SUMMARY

The present disclosure has been made in view of the foregoing problems, and it is an object thereof to provide an air battery module in which, although its structure is simple, the connection resistance between components is low and the occurrence of misalignment between components and distortion of components during assembly can be reduced.

To achieve the above object, an air battery module of the present disclosure includes a plurality of air battery cells connected in series in one direction. Each of the plurality of air battery cells includes a negative electrode current collector, a negative electrode plate, a separator, a positive electrode current collector supporting an air electrode, a water-repellent film, and a flow channel plate that are sequentially stacked in the one direction. The positive electrode current collector includes a conductive frame that supports the air electrode and is electrically connected to the air electrode and a conductive connection part that is formed integrally with the frame and extends in a direction intersecting a frame plane of the frame, the direction being away from the negative electrode current collector. The connection part includes at least two connection parts that are formed so as to face each other with the air electrode supported by the frame interposed therebetween. The plurality of air battery cells include a first air battery cell and a second air battery cell. When a negative electrode side of the second air battery cell is connected to a positive electrode side of the first air battery cell, at least one of the at least two connection parts of the positive electrode current collector of the first air battery cell is contact with the negative electrode current collector of the second air battery cell to establish electrical connection therebetween. In the air battery module of the present disclosure, the connection parts increase the stiffness of the positive electrode current collector, and therefore the occurrence of distortion of the positive electrode current collector after the air electrode is attached to the frame can be suppressed. Moreover, the distortion of the positive electrode current collector when the negative electrode side of the second air battery cell is connected to the positive electrode side of the first air battery cell can be reduced, and the accuracy of assembly is improved.

### BRIEF DESCRIPTION OF THE DRAWINGS

The present disclosure will become more fully understood from the detailed description given hereinafter and the accompanying drawings which are given by way of illustration only, and thus, are not limitative of the present disclosure, and wherein:

FIG. 1 is a perspective view showing an air battery module according to one embodiment;

FIG. 2 is an exploded perspective view of one air secondary battery cell;

FIG. 3 is a plan view showing an example of air electrodes welded to a positive electrode current collector; and

FIGS. 4A and 4B are an exploded view and a cross-sectional view, respectively, of two battery cells adjacent to each other in a stacking direction, illustrating the electrical connection between a positive electrode current collector of one of the battery cells and a negative electrode current collector of the other battery cell.

### DETAILED DESCRIPTION

An air battery module according to an embodiment will hereinafter be described with reference the drawings.

### 1. Structure of Battery Cells

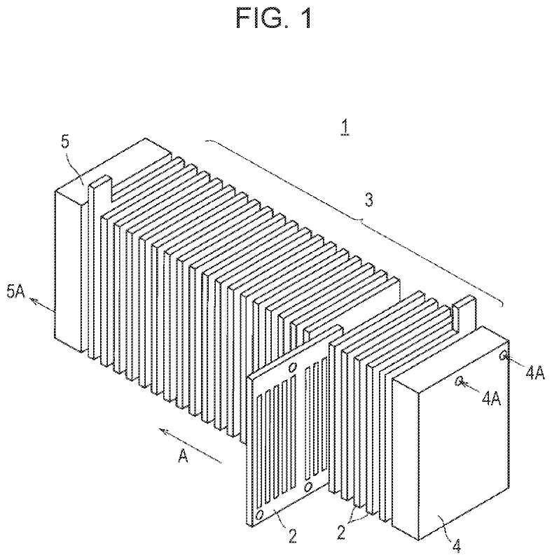

FIG. 1 shows the air battery module. The air battery module (hereinafter also referred to as “battery module”) 1 includes a battery assembly 3 including 60 air secondary battery cells 2 (hereinafter also referred to as “battery cells”) arranged in a row in a direction A and connected in series and a pair of clamping plates 4 and 5 that hold opposite ends of the battery assembly 3 therebetween.

Each of the battery cells 2 includes a gasket 11, a flow channel plate 12, a water-repellent film 13, a positive electrode current collector 15 supporting an air electrode 14, a separator 16, a negative electrode plate 17, a gasket 18, and a negative electrode current collector 19 that are sequentially stacked in the direction A from the positive electrode side toward the negative electrode side.

The flow channel plate 12 is formed of a conductive rectangular flat plate and has flow channels through which air drawn from the outside of the battery module 1 and to be reacted with the air electrodes 14 flows. The flow channels are in communication with air supply ports 20 through which air is introduced from the outside of the battery module 1 and in communication with air discharge ports 21 through which the air flowing through the flow channels is guided to the outside. For example, the flow channels in the flow channel plate 12 are formed by corrugating a metal plate by press forming, as projections and recesses formed by subjecting a resin material to mold pressing, or as a gas diffusion layer formed of a porous material. The flow channels in the flow channel plate 12 can have any suitable form so long as air can be supplied to the entire air electrodes 14. The gasket 11 is attached so as to surround the flow channel plate 12.

The water-repellent film 13 is positioned between the flow channel plate 12 and the air electrodes 14, allows air to pass therethrough during charging and discharging, and closes the flow channels so that an electrolyte in the battery cell 2 does not leak into the flow channels. The water-repellent film 13 serves as a liquid-tight, air-permeable film and is formed of a water-repellent microporous film made of, for example, PTFE. The water-repellent microporous film allows air to pass therethrough from the flow channel side toward the air electrodes 14 and prevents the electrolyte on the air electrode 14 side from leaking into the flow channels.

The air electrodes 14 each include a conductive substrate and an air electrode mixture layer formed of an air electrode mixture (positive electrode mixture) and held by the substrate and is disposed on the water-repellent film 13 so as to be in close contact therewith. The air electrode mixture contains a redox catalyst for utilizing oxygen reduction-oxygen evolution reactions, a conductive material, a binder, and a water-repellent material. The redox catalyst used is a bifunctional redox catalyst and is preferably pyrochlore-type bismuth ruthenium oxide. At the air electrodes 14, a reaction in which oxygen in air supplied through the water-repellent film 13 is reduced occurs during discharging, and a reaction in which oxygen is generated from water occurs during charging. The oxygen generated is discharged to the flow channels through the water-repellent film 13. The electrons generated at the air electrodes 14 are collected by the positive electrode current collector 15. To reduce the resistance value of the air electrodes 14, it is preferable that the substrates are welded and connected to the positive electrode current collector 15. The production of the air electrodes 14 will be described later.

The positive electrode current collector 15 is produced using a metal plate having a surface subjected to corrosion resistant treatment and has a rectangular frame 15A. The frame 15A is formed by subjecting a metal plate to punching such that an inner side portion of the metal plate is cut out according to the shape of the substrates of the air electrodes 14. The side portions of the frame 15A each have a predetermined width. Outer edge portions 14A of the substrates of the air electrodes 14 are welded to inner edge portions of the frame 15A, and the frame 15A thereby supports the air electrodes 14. The thickness of the positive electrode current collector 15 is determined in consideration of the case of processing, the energy density of the battery cell 2, and its internal resistance and is preferably 0.1 mm to 0.3 mm.

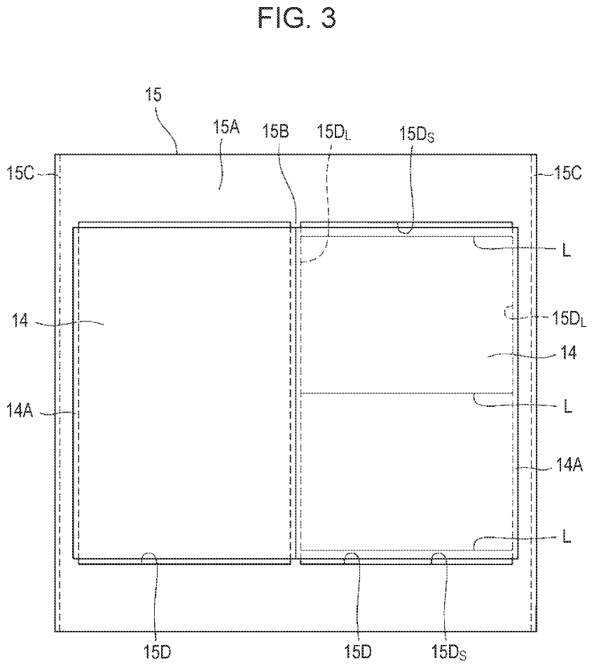

When the size of the battery cell 2 is large or the area of the air electrodes 14 is large, a conductive beam 15B is integrally formed in a central portion of the frame 15A of the positive electrode current collector 15 in order to increase the ability to collect the current from the air electrodes 14, as shown in FIG. 3. The beam 15B divides the frame into two portions to form two openings 15D, and the air electrodes 14 are housed in the openings 15D. Each of the openings 15D has a rectangular shape in which an edge portion of the beam 15B and an inner edge portion serve as long sides 15D_{L}, and inner edge portions of the frame 15A orthogonal to the long sides 15D_{L} serve as short sides 15D_{S}. The air electrodes 14 housed in the openings 15D of the frame 15A are resistance-welded to the frame 15A of the positive electrode current collector 15 and thereby electrically connected to the positive electrode current collector 15.

The positive electrode current collector 15 further includes connection parts 15C formed integrally with outer circumferential edge portions of the frame 15A so as to face each other with the beam 15B interposed therebetween. The connection parts 15C are formed by bending outer circumferential edge portions of the frame 15A in the same direction intersecting the frame plane of the frame 15A. In the present embodiment, as shown in FIG. 3, the connection parts 15C are formed by bending outer edge portions of the side portions of the frame 15A to which the substrates of the air electrodes 14 are to be welded. Specifically, 1 mm-wide outer edge portions of the side portions are bent at an angle of 60 degrees with respect to the in-plane direction of the frame 15A.

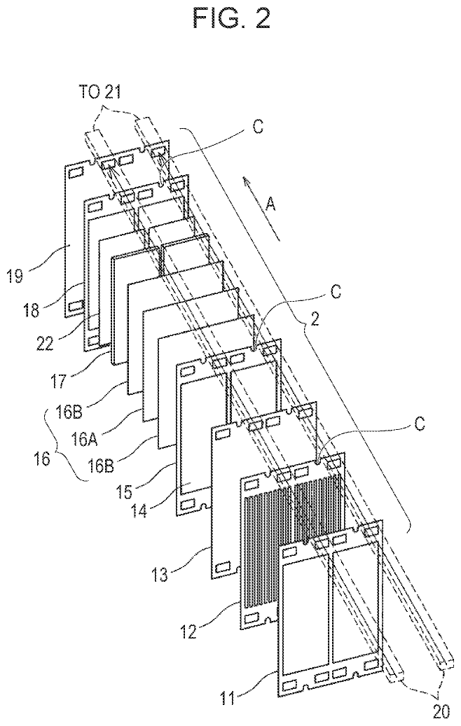

The separator 16 is disposed between the air electrodes 14 and the negative electrode plates 17 to electrically isolate the air electrodes 14 from the negative electrode plates 17. The separator 16 is produced using, for example, a nonwoven fabric made of polyamide fibers or a nonwoven fabric made of polyolefin fibers and contains therein an alkaline electrolyte such as a KOH solution. In the present embodiment, the separator 16 has a rectangular overall shape. As shown in FIG. 2, the separator 16 can have a three-layer structure in which a hydrophilic-treated PP microporous film 16A is sandwiched between nonwoven fabrics 16B from opposite sides.

Each of the negative electrode plates 17 includes a conductive negative electrode core having a large number of pores and a negative electrode mixture held in the pores and on the surface of the negative electrode core. The negative electrode core used is, for example, foamed nickel. The negative electrode mixture contains a hydrogen storage alloy powder serving as a negative electrode active material, a conductive agent, and a binder. The conductive agent used may be graphite, carbon black, etc. The production of the negative electrode plates 17 will be described later.

The negative electrode current collector 19 is produced so as to have a rectangular shape using a conductive metal plate having a surface subjected to corrosion resistant treatment. The negative electrode current collector 19 abuts against the negative electrode plates 17 to collect electrons. The separator 16 and the negative electrode plates 17 are housed inside the gasket 18 having a tubular shape.

Preferably, a plate 22 formed of foamed nickel is held between the negative electrode plates 17 and the negative electrode current collector 19 as a member for improving the current collecting ability and absorbing a dimensional change due to expansion and contraction of the electrode plates during charging and discharging.

To facilitate alignment when the flow channel plate 12, the positive electrode current collector 15, and the negative electrode current collector 19 are stacked, the positive electrode current collector 15 has cuts C at opposite edge portions with respect to the longitudinal direction of the beam 15B as shown in FIG. 2, and the flow channel plate 12 and the negative electrode current collector 19 also have cuts C at positions near their circumferential edge portions corresponding to the opposite edge portions of the positive electrode current collector 15 when they are stacked together. In the present embodiment, the flow channel plate 12, the positive electrode current collector 15, and the negative electrode current collector 19 each have four U-shaped cuts C.

In each battery cell 2, the gasket 11, the flow channel plate 12, the water-repellent film 13, the positive electrode current collector 15 supporting the air electrodes 14, the gasket 18, and the negative electrode current collector 19 are stacked while being positioned using the cuts C, and the air supply ports 20 and the air discharge ports 21 are formed so as to pass through the battery cell 2 in the stacking direction. The air supply ports 20 are in communication with air supply ports 4A of the clamping plate 4 attached to one end side of the battery module 1. The air discharge ports 21 are in communication with air discharge ports 5A of the clamping plate 5 attached to the other end side of the battery module 1. Each of the battery cells 2 has the structure described above.

### 2. Production of Battery Cells and Battery Module 1

The production of the battery cells 2 and the battery module 1 including the battery cells 2 connected in series will be described.

### (1) Production of Air Electrodes

To produce the air electrodes 14, pyrochlore-type metal oxide Bi₂Ru₂O_{7-Z} was used as an oxygen reduction-oxygen evolution bifunctional catalyst contained in the air electrode mixture.

Bi(NO₃)₃·5H₂O and RuCl₃·3H₂O were added to an aqueous dilute nitric acid solution at 75° C. such that their molar concentration ratio was 0.75:1.00, and the mixture was stirred to produce an aqueous solution mixture of Bi(NO₃)₃·5H₂O and RuCl₃·3H₂O. A 2 mol/L aqueous NaOH solution was added to the aqueous solution mixture. The bath temperature during the addition was set to 75° C., and the aqueous solution mixture with the aqueous NaOH solution added thereto was stirred under oxygen bubbling. The precipitate generated by this procedure was collected by suction filtration and dried to thereby obtain a precursor powder. The obtained precursor was subjected to heat treatment including heating the precursor to 540° C. in an air atmosphere and holding the heated precursor for 3 hours to thereby obtain a fired product. The obtained fired product was subjected to suction filtration sequentially with distilled water at 75° C., a 2 mol/L aqueous nitric acid solution, and distilled water at 75° C. to remove byproducts by washing. The resulting fired product was collected by suction filtration, heated to 120° C., and dried to thereby obtain an air electrode catalyst (bismuth ruthenium oxide catalyst) for a hydrogen-air secondary battery. The primary particle diameter of the air electrode catalyst obtained by observation under an SEM was 10 to 50 nm.

The bismuth ruthenium oxide catalyst was pulverized using a wet bead mill (LABSTAR Mini DMS65 manufactured by Ashizawa Finetech Ltd.). Ion exchanged water was added to the pulverized bismuth ruthenium oxide catalyst such that the ratio of the bismuth ruthenium oxide catalyst in solid form per unit weight was 20 wt %. Then a dispersant (SN dispersant 5468, SAN NOPCO LIMITED) was added in an amount of 2 wt % with respect to the weight of the catalyst to produce a catalyst dispersion. The catalyst dispersion was pumped into a bead milling machine at a predetermined flow rate and pulverized with zirconia beads (bead diameter ϕ: 0.1 mm) at a peripheral speed of 8 m/s. The discharged process solution was again fed to the bead milling machine, and the pulverizing treatment and discharge process were repeated a total of 5 times (5 passes were performed) to obtain a dispersion with a bismuth ruthenium oxide concentration of 20 wt %.

The dispersion was weighed such that the weight of the bismuth ruthenium oxide was 50 parts by mass. To the weighed dispersion were added 30 parts by mass of high-purity natural graphite (SNO-IT manufactured by SEC CARBON, LIMITED, average particle diameter: 1 to 2 μm) used as a carbon material, 30 parts by mass, in terms of solid content, of an FEP dispersion (perfluoroethylene propane copolymer 120-JRB manufactured by Chemours-Mitsui Fluoroproducts Co., Ltd., average particle diameter: 0.2 μm) used as a fluorocarbon resin, and 1 part by mass of hydroxypropyl cellulose (HPC) used as a viscosity modifier. Then ion exchanged water was further added to adjust the viscosity. In this case, the total amount of water in the slurry is the sum of the amount of the additionally added ion exchanged water, the amount of the ion exchanged water contained in the dispersion, and the amount of water contained in the FEP dispersion and was 385 parts by mass. These materials were mixed and stirred in a rotation-revolution mixer. Then the weight ratio of the solids, excluding the weight of the ion exchanged water and the weight of water contained in the FEP dispersion, in the resulting slurry was 21.4% of the total weight of the slurry. The weight ratios of the bismuth ruthenium oxide, graphite, fluorocarbon resin, HPC, and dispersant contained in the solids were 44.9%, 26.9%, 26.9%, 0.9%, and 0.4%, respectively.

Foamed nickel in the form of a roll (thickness: 1.6 mm, average pore diameter: 580 μm, basis weight: 575 g/m²) used as the substrate was rolled between rolls in advance to a thickness of 0.45 mm, and the width of a portion to be filled was set to 80 mm. To produce a positive electrode mixture layer, the foamed nickel was filled with the slurry with uncoated portions provided at opposite ends.

Next, the foamed nickel filled with the slurry was dried at 60° C. for 1 hour and rolled between rolls to 0.20 mm. The air electrode obtained was cut into a piece such that its long-side length was 125 mm, and then the cut piece was cut such that its short-side length was 84 mm with each uncoated portion having a width of 2 mm.

The air electrode obtained was fired in an electric furnace at 250° C. for 13 minutes in a nitrogen gas flow at a flow rate of 1 L/min. The weight of the dried slurry (air electrode mixture) applied to the foamed nickel was computed from the difference between the weight of the obtained air electrode and the weight of the foamed nickel used as the substrate, and the amount of the bismuth ruthenium oxide catalyst per unit area was computed from the weight ratio of its amount added. Then the amount of the catalyst in the air electrode was found to be 7.5 mg/cm².

### (2) Production of Negative Electrode Plates

Metal materials, i.e., Nd, Mg, Ni, and Al, were mixed such that a predetermined molar ratio was obtained, and the mixture was placed in a high-frequency induction melting furnace and melted in an argon gas atmosphere. The obtained molten metal was poured into a mold and cooled to a room temperature of 25° C. to thereby produce an ingot.

Next, the ingot was held in an argon gas atmosphere at a temperature of 1000° C. for 10 hours to heat-treat the ingot and then cooled to a room temperature of 25° C. The cooled ingot was mechanically pulverized in an argon gas atmosphere to obtain a rare earth-Mg—Ni-based hydrogen storage alloy powder. The volume average particle diameter (MV) of the obtained rare earth-Mg—Ni-based hydrogen storage alloy powder was measured using a laser diffraction-scattering particle size distribution measurement apparatus. The volume average particle diameter (MV) was found to be 65 μm.

The composition of the hydrogen storage alloy powder was analyzed by inductively coupled plasma spectrometry (ICP) and was found to be Nd_{0.89}Mg_{0.11}Ni_{3.23}Al_{0.17}.

Next, 0.25 g of the hydrogen storage alloy powder used as the negative electrode active material and 0.75 g of nickel powder were mixed and molded to thereby produce a 10 mmϕ pellet electrode. 100 mL of an 8 mol/L aqueous KOH solution was placed in a cylindrical container. The pellet electrode and a mercury oxide reference electrode were inserted into a central portion of the container, and a nickel hydroxide counter electrode having a larger capacitance than the negative electrode was placed along the edge of the container. A charge-discharge test was performed on the negative electrode capacity-regulated battery to determine an electrochemical alloy capacity. Specifically, the negative electrode capacity of the battery computed by assuming that the capacity of the alloy was 300 mAh/g was defined as 1 It. Then the battery was charged at 0.5 It×200 minutes and discharged at 0.5 It until the negative electrode potential with respect to the mercury oxide reference electrode reached −0.3 V. The electrochemical capacity obtained was 350 mAh/g.

0.2 parts by mass of sodium polyacrylate, 0.04 parts by mass of carboxymethyl cellulose, 0.3 parts by weight of carbon black, and 22.4 parts by weight of water were added to 100 parts by weight of the obtained hydrogen storage alloy powder. The mixture was kneaded to produce a negative electrode mixture paste.

A sheet of nickel foam used as a negative electrode core was filled with the negative electrode mixture paste. The thickness of the nickel foam was 1.6 mm, and its basis weight was 300 g/m². The nickel foam holding the negative electrode mixture was dried and then rolled between rolls to increase the amount of the alloy per unit volume. Then the nickel foam was cut to obtain a negative electrode plate 17 having a size of 80 mm×125 mm. The filling amount of the negative electrode alloy was adjusted such that the capacity computed using the alloy capacity described above was 15.6 Ah.

### (3) Production of Members Included in Battery Cell

The flow channel plate 12 was produced by subjecting a SUS316L steel material having a thickness of 0.1 mm to die press forming into a corrugated shape to form the flow channels. The depth of the flow channels formed in the flow channel plate 12 is 0.4 mm, and their pitch is 2 mm. The height of the flow channel plate 12 combined with the plate thickness is 0.5 mm. The air supply ports 20, the air discharge ports 21, and U-shaped cuts C were produced in the formed flow channel plate 12 by laser cutting. The size of the flow channel plate 12 is 180 mm×180 mm.

The water-repellent film 13 was produced by forming supply ports, discharge ports, and U-shaped cuts C in a microporous PTFE film by Thomson processing. The size of the water-repellent film 13 is 180 mm×180 mm.

The positive electrode current collector 15 was produced as follows. A Ni-plated 0.2 mm-thick SPCC steel material was shaped into a frame shape by laser cutting to produce the frame 15A, and air supply ports 20, air discharge ports 21, U-shaped cuts C were formed in the frame portion of the frame 15A. The size of the positive electrode current collector 15 subjected to the laser cutting is 180 mm×182 mm. 1 mm-wide portions of the 182 mm-long side portions were bent at an angle of about 60 degrees in the same direction with respect to the in-plane direction to thereby form the connection parts 15C. The outer edge portions 14A of the air electrodes 14 were resistance-welded to a surface of the frame 15A opposite to the surface from which the connection parts 15C rose.

The negative electrode current collector 19 was produced by forming air supply ports 20, air discharge ports 21, communication holes (not shown) for electrolyte injection, and U-shaped cuts C in a Ni-plated 0.1 mm-thick SPCC steel material by laser cutting. The size of the negative electrode current collector 19 is 180 mm×182 mm.

The gasket 11 was produced by coating both sides of a 0.3 mm-thick SPCC steel sheet with rubber and subjecting the resulting steel sheet to laser cutting. The gasket 11 is shaped to engage with a groove formed in the flow channel plate 12.

The gasket 18 was produced by forming air supply ports 20, air discharge ports 21, hollow portions for housing the negative electrode plates 17, and U-shaped cuts C in a 1 mm-thick PTFE-based joint sheet material by Thomson processing. The size of the gasket 18 is 180 mm×180 mm. In the present embodiment, two hollow portions were formed in the gasket 18, and the size of each of the hollow portions is 82 mm×130 mm.

The clamping plates 4 and 5 were produced from a 12 mm-thick stainless steel plate. The clamping plate 4 is to be attached to the positive electrode side of the battery module 1 and has the air supply ports 4A formed so as to pass therethrough in the sheet thickness direction. The clamping plate 5 is to be attached to the negative electrode side and has the air discharge ports 5A formed so as to pass therethrough in the sheet thickness direction.

(4) Installation of Air Electrodes onto Positive Electrode Current Collector

As described above, the air electrodes 14 are housed in the frame portion of the frame 15A of the positive electrode current collector 15, and the outer edge portions 14A of the substrates of the air electrodes 14 are welded to the inner edge portions of the frame 15A. The air electrodes 14 are welded to the frame 15A and supported thereby. An example of the support structure for the air electrodes 14 by the positive electrode current collector 15 is shown in FIG. 3.

In the present embodiment, two electrodes each having an 80 mm×125 mm catalyst-coated portion (the size of the conductive support was 84 mm×125 mm, and 2 mm-wide uncoated portions extending in the longitudinal direction were provided and used as portions to be welded) were arranged laterally, and the beam 15B having a width of 4 mm was provided in the central portion.

More specifically, as shown in FIG. 3, in the positive electrode current collector 15 having a size of 182 mm (horizontal)×180 mm (vertical), two openings 15D, 15D were formed within the frame 15A by removing rectangular pieces from portions between outer edge portions of the positive electrode current collector 15 and the beam 15B such that the beam 15B having a width of 4 mm remained at the center.

The air electrodes 14 are attached to the openings 15D. The substrates of the air electrodes 14 each have a size of 84 mm (horizontal)×125 mm (vertical). Each of the substrates of the air electrodes 14 has uncoated portions 14A, i.e., outer edge portions 14A, that are 2 mm-wide portions extending in the longitudinal direction and uncoated with the positive electrode mixture. These uncoated portions 14A are resistance-welded to portions near the opposed long sides 15D_{L} of the openings, i.e., the long sides 15D_{L} of the frame 15A and the long sides 15D_{L} on the beam 15B side, to thereby fix the air electrodes 14 to the frame 15A. In this manner, the air electrodes 14 are supported by the positive electrode current collector 15.

1 mm-wide outer circumferential edge portions of the frame 15A facing each other with the beam 15B interposed therebetween are bent toward the side opposite to the side of the frame 15A on which the air electrodes 14 are to be fixed to thereby form the connection parts 15C. Generally, the physical strength of a plate-shaped member whose entire surface is flat can be increased by bending its outer circumferential edge portions in a direction intersecting the in-plane direction. Therefore, since the welds between the air electrodes 14 and the frame 15A are located near the connection parts 15C of the positive electrode current collector 15, distortion and deflection of the positive electrode current collector 15 due to welding are reduced.

### (5) Assembly of Battery Module

Guiding screws 30 each covered with an FEP tube were attached to one of the two clamping plates 4 and 5, i.e., the clamping plate 4, so as to be substantially orthogonal to the principal surface of the clamping plate, and the negative electrode current collector 19 and the gasket 18 were sequentially placed on the clamping plate 4 such that the screws 30 were located in the cuts C. The guiding screws 30 are each an example of a rod-shaped attaching member. The FEP tube is an example of an elastic tube.

A 0.3 mm-thick foamed nickel plate and the negative electrode plates 17 were sequentially placed in the hollow portions of the gasket 18. Then the separator 16 and the positive electrode current collector 15 with the air electrodes 14 welded thereto were stacked. The positive electrode current collector 15 was stacked on the separator 16 such that the direction in which the connection parts 15C of the frame 15A rose was opposite to the direction toward the negative electrode plates 17. Then the water-repellent film 13, the flow channel plate 12, and the gasket 11 were stacked. The positive electrode current collector 15, the water-repellent film 13, the flow channel plate 12, and the gasket 11 were aligned using the engagement of the guiding screws 30 with the cuts C formed in each of these members.

A stacked structure prepared by sequentially stacking the above members including from the negative electrode current collector 19 to the gasket 11 as described above was used as one set, and 60 sets were sequentially stacked in one direction. In each set, the positive electrodes (air electrodes) and the negative electrode plates 17 face each other with the separator 16 interposed therebetween. Therefore, each set forms a single battery cell 2.

Sixty battery cells 2 were stacked in one direction using the guiding screws 30 and connected in series. One additional negative electrode current collector 19 was stacked, and then the clamping plate 5 was stacked. Note that the last stacked negative electrode current collector 19 is not part of any battery cell 2.

Next, the clamping plates 4 and 5 were tightened with the screws 30 while a load of 8 t was applied using a vertical press to thereby assemble the battery module 1. An electrolyte can be sealed inside the assembled battery module 1.

The negative electrode current collector 19 of the battery cell 2 that was stacked first was used as a negative electrode terminal of the battery module 1. The positive electrode current collector 15 of the last stacked battery cell 2 and the negative electrode current collector 19 in contact with this positive electrode current collector 15 were connected and integrated together, and the integrated member was used as a positive electrode terminal of the battery module 1. The presence or absence of leakage in the battery module 1 was checked, and then 1.2 kg of a 5 mol/L aqueous KOH solution used as the electrolyte was poured into the battery module 1.

In the battery module 1, the air supply ports 20 and the air discharge ports 21 of the battery cells 2 are in communication with each other. Therefore, air is introduced into the battery module 1 from the air supply ports 4A of the clamping plate 4 on the positive electrode side, passes through the 60 battery cells 2, and is discharged from the air discharge ports 5A of the clamping plates 5 on the negative electrode side. Specifically, the air is supplied to all the 60 battery cells 2.

The battery module 1 was subjected to aging treatment at 60° C. for 12 hours to activate the negative electrodes and then cooled to room temperature. Then the battery module 1 was charged and discharged while CO₂-depleted air was supplied to the battery module 1 at 6.2 L/min. As for the charge/discharge conditions, 25 Ah corresponding to 80% of the design capacity of the negative electrode was defined as 1 It, and the battery was charged at 0.1 It×10 hours and discharged at 0.05 It (the end-of-discharge voltage E.V. was 42 V).

### (6) Series Connection of Battery Cells

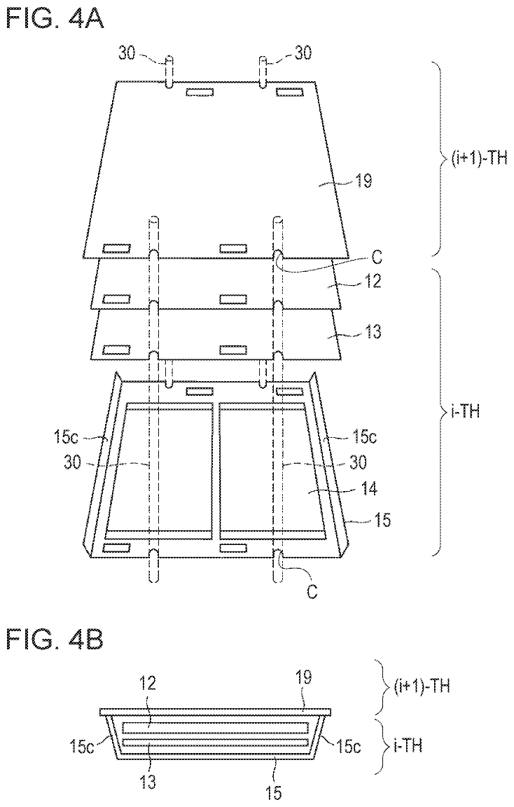

Next, a description will be given of the electrical connection between two battery cells 2 vertically adjacent to each other in the stacking direction in the assembly of the battery module 1 described above. To connect the stacked battery cells 2 in the battery module 1 in series, it is necessary that the positive electrode current collector 15 of the i-th battery cell 2 (i is a natural number of 1≤i≤59) that have already stacked using the guiding screws 30 be electrically connected to the negative electrode current collector 19 of the adjacent (i+1)-th battery cell 2 to be stacked on the i-th battery cell 2. As shown in FIG. 4A, the water-repellent film 13 and the flow channel plate 12 of the i-th battery cell 2 are present between the positive electrode current collector 15 of the i-th battery cell 2 and the negative electrode current collector 19 of the (i+1)-th battery cell 2.

The connection parts 15C of the positive electrode current collector 15 of the i-th battery cell 2 extend toward the negative electrode current collector 19 of the (i+1)-th battery cell 2. Therefore, when the clamping plates 4 and 5 are tightened, these connection parts 15C extending beyond the water-repellent film 13 and the flow channel plate 12 of the i-th battery cell 2 come into contact with and are electrically connected to the negative electrode current collector 19 of the (i+1)-th battery cell 2, as shown in FIG. 4B. The i-th battery cell 2 is an example of the first battery cell, and the (i+1)-th battery cell 2 is an example of the second battery cell.

The positive electrode current collector 15 has a frame shape whose inner portion has been cut out so that the inner shape of the frame conforms to the shape of the air electrodes 14, in order that the positive electrode current collector 15 can support the air electrodes 14 on the inner side. The stiffness of the frame 15A having the frame shape is lower than that of the uncut current collector plate. However, the stiffness of the frame 15A is increased because of the presence of the connection parts 15C that are located near the welds and formed integrally with the frame 15A so as to rise in a direction intersecting the frame plane of the frame 15A. Therefore, the occurrence of distortion and deflection of the positive electrode current collector 15 due to the welding of the air electrodes 14 can be reduced.

### 3. Effects of Shape of Positive Electrode Current Collector

A description will be given of the reduction of the distortion and deflection of the positive electrode current collector 15 by the connection parts 15C.

As described above, the connection parts 15C are formed by bending the 1 mm-wide edge portions of the frame 15A of the positive electrode current collector 15 that are located outward of the portions to which the air electrodes 14 are to be welded. For comparison with the positive electrode current collector 15 having the connection parts 15C, a positive electrode current collector 15 was prepared in which the side portions opposed to each other with the frame 15A to be welded interposed therebetween were not bent. The frame 15A of the positive electrode current collector 15 was disposed such that the frame plane was parallel to the horizontal direction, that a side portion with no connection part 15C served as a fixed end, and that a side portion with a connection part served as a free end. The deflection of the positive electrode current collector 15 by its own weight in the vertical direction was measured. The deflection was measured as follows. The free end and the fixed end were held at the same height, and the held free end was released to allow it to move freely. Then the distance of the movement of the free end in the vertical direction was measured.

Three rectangular positive electrode current collectors each having the connection parts 15C and a side length of 180 mm and having different thicknesses of 0.1 mm, 0.2 mm, and 0.3 mm were designated as Example 1, Example 2, and Example 3, respectively. For comparison purposes, rectangular positive electrode current collectors each having no connection parts, having a side length of 180 mm, and having different thicknesses of 0.1 mm, 0.2 mm, and 0.3 mm were designated as Comparative Example 1, Comparative Example 2, and Comparative Example 3, respectively.

For each positive electrode current collector 15, lengthwise displacement in one of the openings 15D of the positive electrode current collector 15 in the short side 15D_{S} direction before and after the welding of the air electrodes 14, i.e., the amount of distortion of the opening 15D of the positive electrode current collector 15, was examined as follows. For example, as shown in FIG. 3, three imaginary line segments L extending parallel to the short sides 15D_{S} of the opening 15D were drawn from the outer edge portion 14A side of the substrate of one of the air electrodes 14 welded to an inner edge portion 15D_{L} of the frame 15A to an edge of the beam 15B, i.e., a long side 15D_{L} of the opening 15D. Each of the line segments L was regarded as a cantilever spring with one longitudinal end serving as a fixed end and the other longitudinal end serving as a free end. The lengthwise displacement (the amount of distortion of the opening 15D) before and after the welding was examined at three points including the midpoint of the line segment L. The results were represented by the standard deviation as shown in Table 1.

TABLE 1

| | Example | | | Comparative Example | | |
|---|---|---|---|---|---|---|
| | 1 | 2 | 3 | 1 | 2 | 3 |
| Thickness (mm) | 0.1 | 0.2 | 0.3 | 0.1 | 0.2 | 0.3 |
| Connection parts | Yes | Yes | Yes | No | No | No |
| Deflection before welding (mm) | 1.8 | 1.1 | 0.2 | 7.3 | 3.0 | 1.5 |
| Standard deviation of lengthwise | 0.11 | 0.04 | 0.01 | 0.15 | 0.13 | 0.03 |
| displacement before and after | | | | | | |
| welding at end on fixed end side of | | | | | | |
| inner edge portion of frame, center, | | | | | | |
| and end on free end side (mm) | | | | | | |

As can be seen from Table 1, in the Examples each including the connection parts 15C, the “Deflection before welding” was 1.8 mm in Example 1, 1.1 mm in Example 2, and 0.2 mm in Example 3, and the deflection decreases as the thickness increases. In the Comparative Examples each including no connection parts 15C, the “Deflection before welding” was 7.3 mm in Comparative Example 1, 3.0 mm in Comparative Example 2, and 1.5 mm in Comparative Example 3, and the deflection decreases as the thickness increases, as in the Examples. As can be seen by comparing the Examples with the Comparative Examples, the deflection before welding in each of Examples 1 to 3 including the connection parts 15C is equal to or less than one-half that in the corresponding Comparative Example with the same thickness, and the degree of deflection is smaller at any thickness.

Next, the “Standard deviation of lengthwise displacement before and after welding at end on fixed end side of inner edge portion of frame, center, and end on free end side” was 0.11 mm in Example 1, 0.04 mm in Example 2, and 0.01 mm in Example 3, and the displacement in the inner edge portion of the frame decreases as the thickness increases. In the Comparative Examples with no connection parts 15C, the “Standard deviation” was 0.15 mm in Comparative Example 1, 0.13 mm in Comparative Example 2, and 0.03 mm in Comparative Example 3, and the displacement in the inner edge portion of the frame decreases as the thickness increases, as in the Examples.

As described above, as for the deflection before welding and the standard deviation of the displacement of the inner edge portion of the frame 15A after the welding, the deflection by the own weight and welding and the distortion during welding are smaller when the positive electrode current collector 15 has the connection parts 15C. As the thickness of the positive electrode current collector 15 increases, the amount of deflection or the amount of distortion decreases.

By increasing the thickness of the positive electrode current collector 15, the stiffness increases, and the deflection is reduced. However, the air electrodes 14 and components other than the negative electrode are increased in volume and weight, and therefore the energy density of the battery cells 2 decreases. If the thickness is 0.4 mm or more, it is difficult to bend the outer edge portions of the frame 15A, so that the connection parts 15C cannot be produced with high accuracy. Therefore, the thickness of the positive electrode current collector 15 is optimally 0.1 to 0.3 mm and more preferably 0.2 to 0.3 mm.

Since the 1 mm-wide outer edge portions of the frame 15A of the positive electrode current collector 15 are bent to form the connection parts 15C, the deformation caused by welding the air electrodes to the frame 15A can be reduced.

In the present embodiment, the 1 mm-wide outer edge portions of the frame 15A are bent at an angle of 60 degrees with respect to the in-plane direction to form the connection parts 15C. For example, the height of the connection parts 15C of the positive electrode current collector 15 of the i-th battery cell 2 is less than 1 mm. However, the length of the connection parts 15C in the stacking direction is larger than the sum of thicknesses of the flow channel plate 12 and the flow channel plate 12 of the i-th battery cell 2. Therefore, the connection parts 15C reliably come into contact with the negative electrode current collector 19 of the (i+1)-th battery cell 2, and the i-th battery cell 2 is thereby connected to the (i+1)-th battery cell 2 in series. The flow channel plate 12 and the water-repellent film 13 of the i-th battery cell 2 are disposed so as to be sandwiched between the positive electrode current collector 15 of the i-th battery cell 2 and the negative electrode current collector 19 of the (i+1)-th battery cell 2 adjacent thereto. With the structure in the present embodiment in which the positive electrode current collector includes the connection parts 15C, battery cells 2 adjacent to each other can be connected in series.

Since the connection parts 15C of the positive electrode current collector 15 can increase the stiffness as described above, it is unnecessary to increase the thickness of the positive electrode current collector 15 and the size of the beam 15B. Therefore, the energy density of the battery module 1 can be maintained.

Moreover, since the occurrence of distortion of the positive electrode current collector 15 is reduced, the misalignment of the stacked battery cells 2 clamped between the clamping plates 4 and 5 can be reduced.

In the present embodiment, the 60 battery cells 2 are stacked together as described above, and each battery cell 2 includes two gaskets A and B. Therefore, a total of 120 gaskets are arranged in a row for sealing. Since the distortion and deflection of the positive electrode current collectors 15 are small, each gasket is uniformly compressed, so that pressure loss is unlikely to occur in the flow channels of each flow channel plate 12. Therefore, air can be uniformly distributed to the battery cells 2, and the voltage difference or capacity difference between the battery cells 2 is reduced. In this manner, the causes of the reduction in the service life of the battery can be reduced.

Moreover, the U-shaped cuts C are formed in the flow channel plate 12, the negative electrode current collector 19, and the positive electrode current collector 15, and the screws 30 covered with the elastic tubes are used as guides to stack the battery cells 2. Since the cuts C have a U shape, the members forming the battery cells 2 can be stacked smoothly.

Since the distortion and deflection of the positive electrode current collector 15 to which the air electrodes 14 are welded are small, the battery cells 2 can be stacked with high accuracy to assemble the battery module 1.

### 4. Evaluation of Battery Characteristics

The DC resistance of the activated battery module 1 was small, i.e., 3 mΩ per battery cell 2. The small internal resistance of the battery cell 2 may be due to the following reasons.
(a) The substrates of the air electrodes 14 are welded to the frame 15A of the positive electrode current collector 15, and electrical continuity is accurately achieved.
(b) The positive electrode current collector 15 of the i-th battery cell 2 is accurately in contact with the negative electrode current collector 19 of the (i+1)-th battery cell 2 that is adjacent to this positive electrode current collector 15 through the connection parts 15C, and the electrical connection therebetween is thereby established.
(c) The plate formed of the foamed nickel is interposed between the negative electrode current collector 19 and the negative electrode plates 17. In this manner, the dimensional change of the battery cells 2 in the stacking direction is absorbed, and the contact between the negative electrode current collector 19 and the negative electrode plates 17 is well maintained.

The battery voltage of every five cells among the 60 battery cells 2 connected in series in the battery module 1 was monitored during charging and discharging. Variations in the battery capacity were smaller than those in a battery module 1 including battery cells 2 each including a positive electrode current collector 15 with no connection parts 15C, and very stable charge-discharge characteristics with an Ah efficiency of 99.4% were achieved.

Embodiments of the present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An air battery module comprising:
a plurality of air battery cells connected in series in a first direction,
wherein each of the plurality of air battery cells comprises a negative electrode current collector, a negative electrode plate, a separator, a positive electrode current collector supporting an air electrode, a water-repellent film, and a flow channel plate that are sequentially stacked in the first direction,
wherein the positive electrode current collector comprises:
a conductive frame that supports the air electrode and is electrically connected to the air electrode; and
a conductive connection part structure that is formed integrally with the conductive frame and extends in an extending direction intersecting a frame plane of the conductive frame, the extending direction being away from the negative electrode current collector,
wherein the conductive connection part structure comprises at least two connection parts that are formed so as to face each other with the air electrode supported by the frame interposed therebetween, and
wherein the plurality of air battery cells comprise a first air battery cell and a second air battery cell, and when a negative electrode side of the second air battery cell is connected to a positive electrode side of the first air battery cell, at least one of the at least two connection parts of the positive electrode current collector of the first air battery cell is in contact with the negative electrode current collector of the second air battery cell to establish electrical connection therebetween.

2. The air battery module according to claim 1, wherein the air electrode is resistance-welded to the conductive frame of the positive electrode current collector.

3. The air battery module according to claim 2, wherein a welded portion between the air electrode and the conductive frame is located on an inner side of the at least two connection parts facing each other.

4. The air battery module according to claim 1, further comprising a member made of a foamed metal and sandwiched between the negative electrode current collector and the negative electrode plate.

5. The air battery module according to claim 1, wherein each of the negative electrode current collector, the conductive frame of the positive electrode current collector, and the flow channel plate has at least one of a cut or a protrusion in a circumferential edge portion thereof, and wherein the conductive frame of the positive electrode current collector and the flow channel plate are aligned with the negative electrode current collector using the at least one of the cut or the protrusion.

6. The air battery module according to claim 5, further comprising first and second clamping plates attached to positive and negative electrode sides, respectively, of the plurality of air battery cells connected in series,
wherein each of the negative electrode current collector, the frame of the positive electrode current collector, and the flow channel plate has the cut, and
wherein, in each of the air battery cells, the negative electrode current collector, the negative electrode plate, the separator, the positive electrode current collector, the water-repellent film, and the flow channel plate are stacked using, as a guide, a rod-shaped attaching member fixed to one of the first or second clamping plates and covered with an elastic tube.

7. The air battery module according to claim 1, wherein the conductive frame of the positive electrode current collector has a thickness of 0.1 to 0.3 mm.
